(19) United States
(12) Patent Application Publication
(10) Pub. No.: US 2024/0370837 A1
(43) Pub. Date: Nov. 7, 2024

(54) STATELESS EXPERIENCE APIS FOR BILL PAY SYSTEMS

(71) Applicant: Wells Fargo Bank, N.A., San Francisco, CA (US)

(72) Inventors: Peter Rozovski, Concord, CA (US); Peter Shen, Castro Valley, CA (US); Ramkumar Palavelli, Dublin, CA (US)

(21) Appl. No.: 18/313,128

(22) Filed: May 5, 2023

(51) Int. Cl. G06Q 20/10; G06Q 20/32; G06Q 20/40

(52) U.S. Cl. CPC G06Q 20/102; G06Q 20/3226; G06Q 20/409

(57) ABSTRACT

Systems and techniques may generally be used with a stateless experience application programming interface (API) for bill pay. An example technique may include receiving a first stateless experience application programming interface (API) request including bill payment information, receiving an indication from an authentication server that authentication of a user device failed, and sending, in response to receiving the indication, a reject transaction object to a storage device. The example technique may include receiving a second stateless experience API request including patched bill payment information after side channel authentication, and validating the user device by querying the storage device to determine whether the reject transaction object is present. The example technique may include sending an indication of authorized payment to a bill pay service based on validation of the user device.

### BACKGROUND

There are a growing number of new payment or transfer methods for receiving or sending money or paying a bill. These payment methods employ different technical mechanisms for transferring money, which involve elaborate financial technological background infrastructure. A bill pay service may be used to complete bill payment transactions, such as a medical bill, a utility bill, a credit card bill, or the like.

### BRIEF DESCRIPTION OF THE DRAWINGS

In the drawings, which are not necessarily drawn to scale, like numerals may describe similar components in different views. Like numerals having different letter suffixes may represent different instances of similar components. The drawings illustrate generally, by way of example, but not by way of limitation, various embodiments discussed in the present document.

FIGS. 1-3 illustrate architecture diagrams for using a stateless experience application programming interface (API) in accordance with some examples.

FIG. 4 illustrates a user interface for performing a transaction using a stateless experience API in accordance with some examples.

FIG. 5 illustrates a flowchart showing a technique for using a stateless experience API for bill pay in accordance with some examples.

FIG. 6 illustrates generally an example of a block diagram of a machine upon which any one or more of the techniques discussed herein may perform in accordance with some examples.

### DETAILED DESCRIPTION

The systems and techniques described herein provide for using a stateless application programming interface (API) for completing a transaction, such as payment of a bill. A stateless API is an API that includes sufficient information to complete a transaction without additional data (e.g., without needing to access state information). State information is information that is stored (e.g., permanently) and accessible for use in completing a transaction. Typically, state information includes historical data such as a previous login attempt, application information (e.g., user interface (UI) configuration information), or the like. A stateless system does not store this information, but instead receives any information needed to generate a session via a stateless API request. For example, a stateless experience API request may include UI channel information, application information, login information, etc., in addition to credential information, data request (e.g., transaction information, such as bill pay information), or the like.

Traditional bill pay systems use service-oriented architecture to facilitate bill pay transactions. In such architecture, a UI channel front-end calls a UI-channel back-end, which calls functional web-services, which interact with a database. This traditional system requires storing state information to implement the transaction. However, with increasingly diverse UI channels (e.g., desktop, tablet, mobile browser channels, mobile native (e.g., Android or iOS) UI channels, chat-bot channels, third party applications, social network channels, etc.), storing state information is becoming more burdensome and may become untenable. The growing number of UI channels makes the traditional architecture inefficient, expensive, and slow.

The systems and techniques described herein provide for completing a transaction such as a bill pay transaction using a stateless experience API. In these systems and techniques, a UI front end communicates with a web service via a stateless experience API. The experience API may indicate that the API includes functional API results and business logic of a customer UI experience. The stateless experience API design allows for an API agnostic to any given UI channel implementation. Financial transactions such as bill pay are often frequent targets of fraud attacks. To prevent fraud, the stateless experience fraud-resistant API described herein includes embedded fraud resistance via a particular secure authentication mechanism.

A stateless experience API call sent from a user device may include a request (e.g., to complete a bill pay transaction). A response may be sent via the API to the user device. The response may include business logic sufficient to render a UI on the user device. An example API may include a representational state transfer (REST) API, which may include using a hypermedia as the Engine of Application State (HATEOAS) link for following a transaction. When a business rule changes, the API response may be modified, which is usable with any stateless experience API request (instead of the traditional system, which may require a modification to every state storage related to the business rule change).

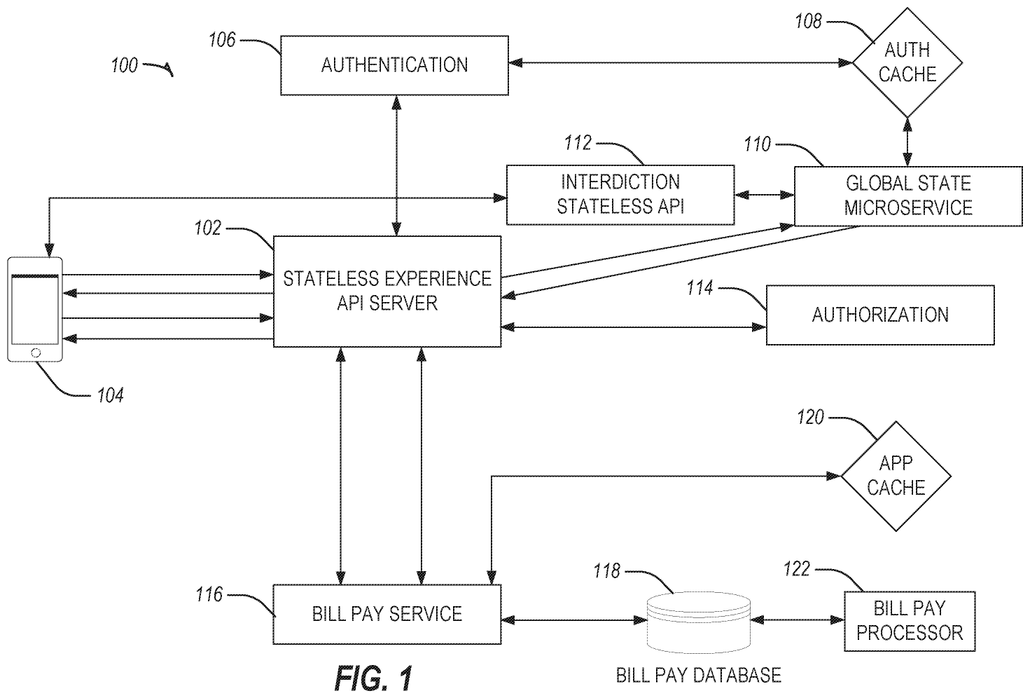

FIG. 1 illustrates an architecture diagram 100 for using a stateless experience API in accordance with some examples. The architecture diagram 100 illustrates various components that may be used to complete a transaction (e.g., a bill pay transaction) for a user. A stateless experience API server 102 may be used to receive a stateless experience API request from a user device 104. The user device 104 may send a stateless experience API request including payment information (e.g., bill pay information) to the stateless experience API server 102. The stateless experience API server 102 may obtain payee domain data from a bill pay service 116. The bill pay service 116 may obtain the payee domain data or user session information from an application cache 120. The stateless experience API server 102 may authenticate the user device 104 by sending information from the stateless experience API request to an authentication service 106. The authentication service 106 may extract a login identifier or an account number using a token identifier in the information. The authentication service 106 may fetch a token (e.g., a signed JavaScript Object Notation (JSON) web token (JWT) token) from an authentication cache 108.

In an example, when the authentication of the user device 104 is successful, the stateless experience API server 102 may send a request for authorization to an authorization service 114 (e.g., to verify sufficient funds, to verify payee or payor information, etc.). After authorization is received from the authorization service 114, the stateless experience API server 102 may submit transaction information (e.g., bill pay information) to the bill pay service 116 for completion of the transaction. The transaction may be completed by the bill pay service 116 creating a payment transaction stored in a bill pay database 118. A bill pay processor 112 may retrieve the payment transaction from the bill pay database 118 to complete the transaction.

In another example, when the authentication of the user device 104 is initially unsuccessful (e.g., the authentication service 106 or the authorization service 114 indicates a mismatch or other issue), the stateless experience API server 102 may generate a reject transaction object, and send the reject transaction object to a global state microservice 110. The global state microservice 110 may store the reject transaction object in temporary storage. The stateless experience API server 102 may send an rejection notification to the user device 104 (e.g., via a stateless experience API response). After receiving the rejection notification, the user device 104 may be authenticated via a side channel authentication (e.g., via a one-time password or passcode, via a biometric, via a second device such as two-factor or multi-factor authentication, or the like). The side channel authentication may include sending a stateless experience API request to an interdiction stateless experience API service 112, which may in some examples communicate with the authentication service 106 or may separately authenticate the user device 104. When the interdiction stateless experience API service 112 authenticates the user device 104 via the side channel, the interdiction stateless experience API service 112 may send an update to the global state microservice 110 indicating that the reject transaction object is to be deleted or overwritten and a valid transaction object is to be saved or to overwrite the reject transaction object, or the interdiction stateless experience API service 112 may write to the global state microservice 110 temporary storage.

After side channel authentication, the user device 104 may send patched information for the transaction via a second stateless experience API request to the stateless experience API server 102. In some examples, this second stateless experience API request may be stateless with respect to the first stateless experience API request that initially requested a transaction (e.g., the stateless experience API server 102 may store no information related to the first request and still be able to respond to the second stateless experience API request). The stateless experience API server 102 may query or read from the global state microservice 110 to determine whether the user device 104 is authenticated (e.g., whether there is a reject transaction object or a valid transaction object). When the global state microservice 110 includes a valid transaction object for the user device 104, the stateless experience API server 102 may submit the transaction to the bill pay service 116. The transaction may be completed by the bill pay service 116 creating a payment transaction stored in a bill pay database 118. The bill pay processor 112 may retrieve the payment transaction from the bill pay database 118 to complete the transaction.

In some examples of submitting or editing a bill pay payment, the stateless experience API server 102 may receive an indication from the authorization service 114 of an authorization status of the user device 104. The authentication status may include authenticated, denied, or challenge, for example. When the authentication status is authenticated, the stateless experience API server 102 may continue with sending payment information to the bill pay service 116. When the authentication status is denied, the stateless experience API server 102 may take no action or respond to the user device 104 that the payment is denied. In some examples, the stateless experience API server 102 may place the user device 104 or an internet protocol (IP) address associated with the user device 104, on a block list. In some examples, the stateless experience API server 102 may place a fraud alert on an account associated with the denied authentication status of the user device 104. When the authentication status is challenge, the stateless experience API server 102 may set a transaction status as “challenge” in the auth cache 108, for example, using a call to the global state microservice 110. The stateless experience API server 102 may return a response to the user device 104 with a HATEOAS link for the user device 104 to display a challenge display component. The user device 104 may display a challenge prompt, and indicate a need for a response based on a customer preference (e.g., via SMS, one time password, fob key, or the like).

In an example, the stateless experience API server 102 may receive a first stateless experience API request, which requires a challenge. The stateless experience API server 102 may respond to the user device 104 indicating the challenge. Once the challenge is resolved, the user device 104 may send a second stateless experience API request. The second stateless experience API request may be sent to the stateless experience API server 102 or to a different server. Because the requests are stateless, any available server may be used to respond to a request, even when the request is related to a challenge from a previous request. The second stateless experience API request may include an indication of where to query (e.g., temporary memory of the global state microservice 110) for checking for a reject or valid object.

The user device 104 may send a session token in the stateless experience API request to the stateless experience API server 102. The session token may be used to authenticate the user device 104 using the authentication service 106 by comparing to a JWT token stored at the authentication cache 108. The session token may be generated or received by an app or website at the user device 104. The JWT token may be fully encrypted with user authentication, and a user device identifier assigned to the user device 102. In some examples the JWT token may be specific to a particular app or channel used by the user device 102 to send the stateless experience API request. In some examples, a time based keepalive may be used for example for storing a valid transaction object at the global state microservice 110. The keepalive may include a time limit, such as 5, 10, 15, 20, etc. minutes, without needing a new session or token. When a session ends or is terminated, a token for that session may be deleted, overwritten, or forgotten (e.g., not stored further).

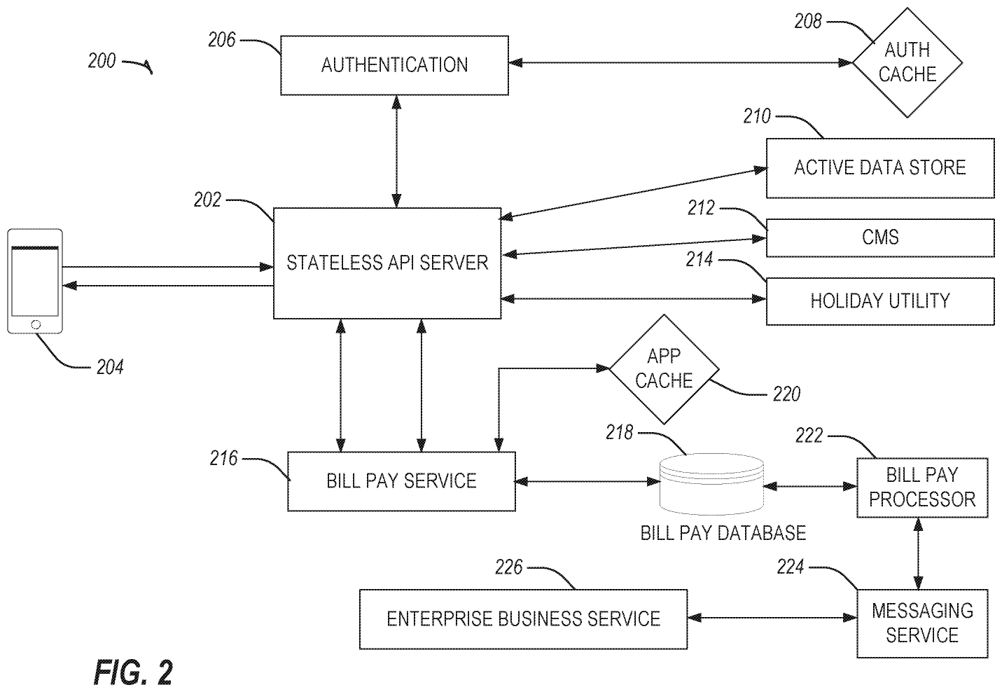

FIG. 2 illustrates an architecture diagram 200 for using a stateless experience API in accordance with some examples. The architecture diagram 200 includes components that may be the same or similar to components of FIG. 1. In the architecture diagram 200, a stateless experience API server 202 may receive a stateless experience API request from a user device 204. The stateless experience API server 202 may authenticate the user device 204 with an authentication service 206 and an authentication cache 208 (e.g., as described above with respect to the authentication service 104 and the authentication cache 108).

The stateless experience API server 202 may receive a request from the user device 204 to obtain information to show in a bill pay user interface. The stateless experience API server 202 may perform asynchronous calls to the bill pay service 216 to retrieve payee, payments, or bill pay eligible accounts. The bill pay service 216 may obtain bill pay user app session or domain data from the bill pay cache 220. The bill pay service 216 may fetch payees, payments, or bill pay eligible accounts from a bill pay database 218. The bill pay database 218 may be updated via a bill pay processor 222, which may receive updates related to accounts from a messaging service 224. The messaging service 224 may receive account change notifications from an enterprise business service 226. The account change notifications may include content changes, openings, closings, etc. In an example, a change to an account or business rule may be made by the enterprise business service 226 and sent to the messaging service 224. The bill pay processor 222 may retrieve the changed information when next requested by the stateless experience API server 202 via the bill pay service 216.

In an example, the stateless experience API server 202 may fetch customer or account details related to the user device 204 or to the stateless experience API request from the user device 204 from an active data store 210. The stateless experience API server 202 may obtain content from a content management system 212 and may retrieve holiday or other public information from a holiday utility 214.

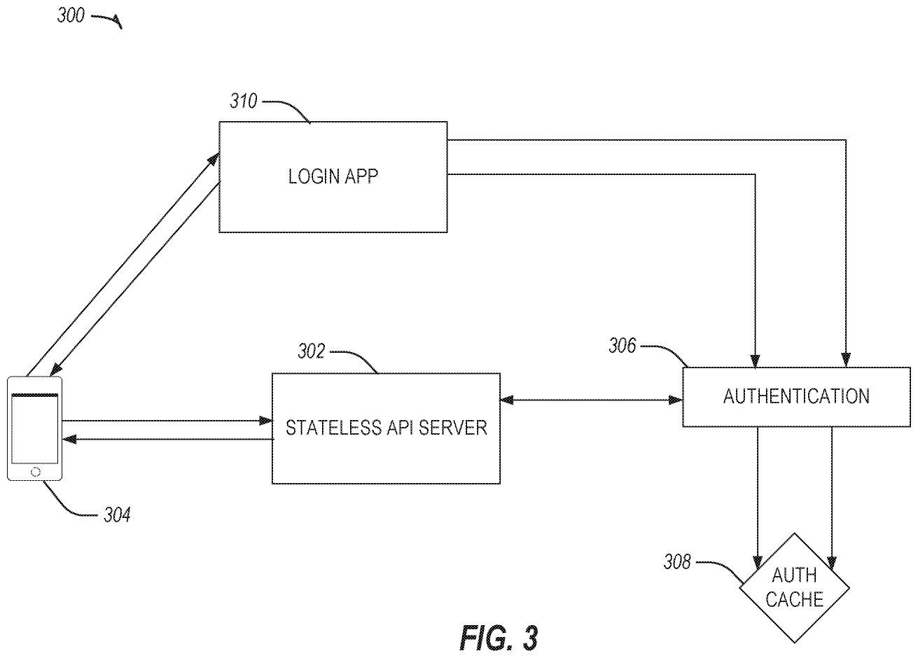

FIG. 3 illustrates a high level architecture diagram 300 for using a stateless experience API in accordance with some examples. The architecture diagram 300 includes components that may be the same or similar to those of FIG. 1 or 2.

The architecture diagram 300 includes a stateless experience API server 302, which may communicate with a user device 304, and an authentication service 306. The user device 304 may include a login application 310.

A customer may login at the user device 304 via the login app 310 using login credentials (e.g., a username or account number and a password). The login app 310 may create a primary authentication context and make a call to the authentication service 306. The authentication service 306 may generate a signed secondary authentication context after the user device 304 is authorized. The login app 310 may send a token identifier to the authentication service 306. The Authentication service 306 may store the signed secondary authentication context, such as a JWT token, in an authentication cache 308. In an example, the user device 304 may set an authorization bearer token identifier in a header of its stateless experience API calls.

After logging in, the user device 304 may access a bill pay user interface to generate a request for context or to pay a bill. A stateless experience API call may be sent from the user device 304 to the stateless experience API server 302. The stateless experience API server 302 may authenticate the user device 304 via the authentication service 306, which may fetch a token from the authentication cache 308. After authentication is complete, the stateless experience API server 302 may respond to the stateless experience API request from the user device 304 with bill pay context or confirmation of paying a bill.

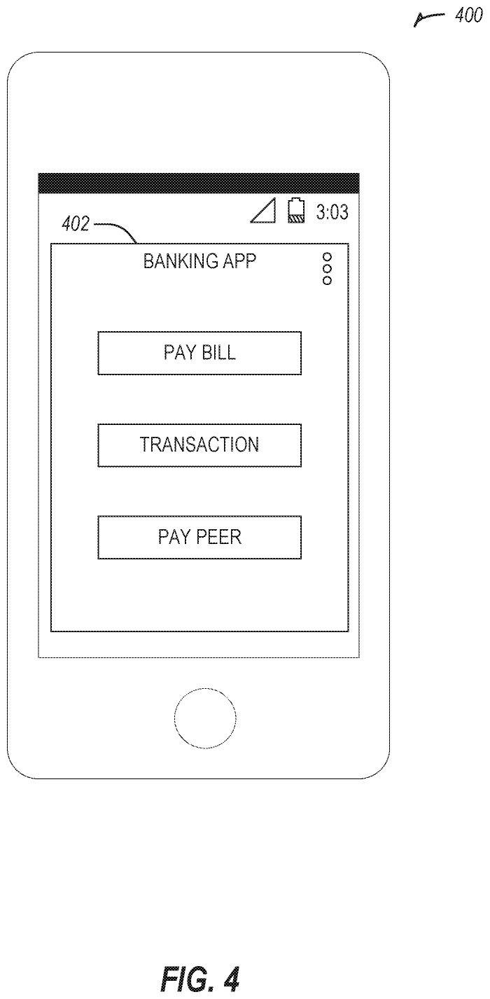

FIG. 4 illustrates a user interface 400 for performing a transaction using a stateless experience API in accordance with some examples. The user interface 400 includes an example banking app 402 that may be used to login, pay a bill, or perform some other transaction. In some examples, the user interface 400 may display a different app, a webpage, or the like. A user may select the bill pay option, and enter or select information to generate a stateless experience API request to be sent to a server.

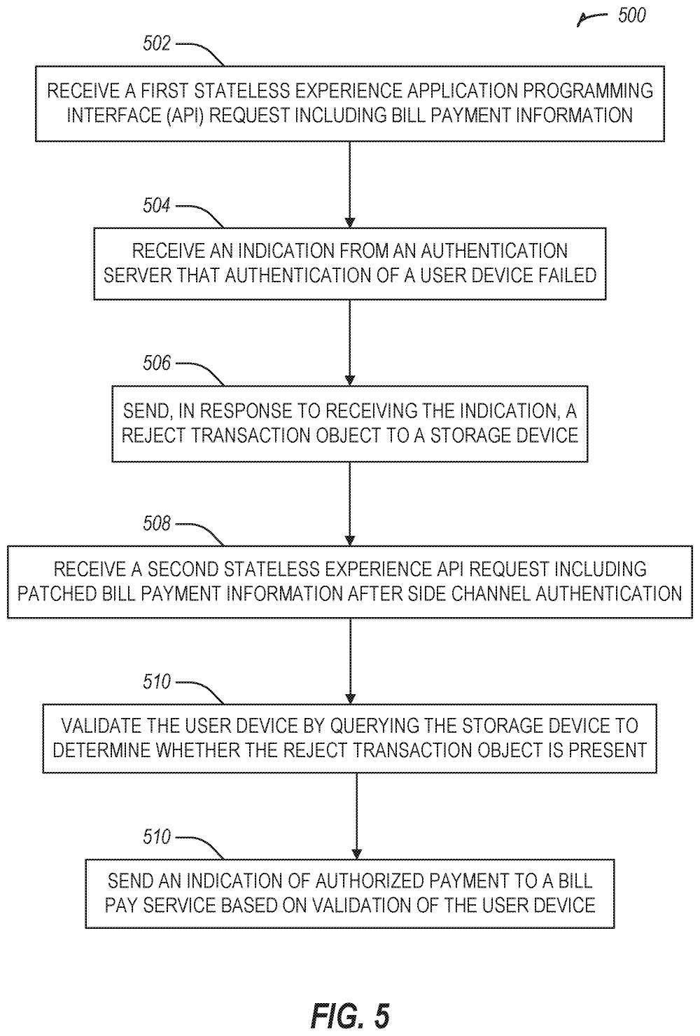

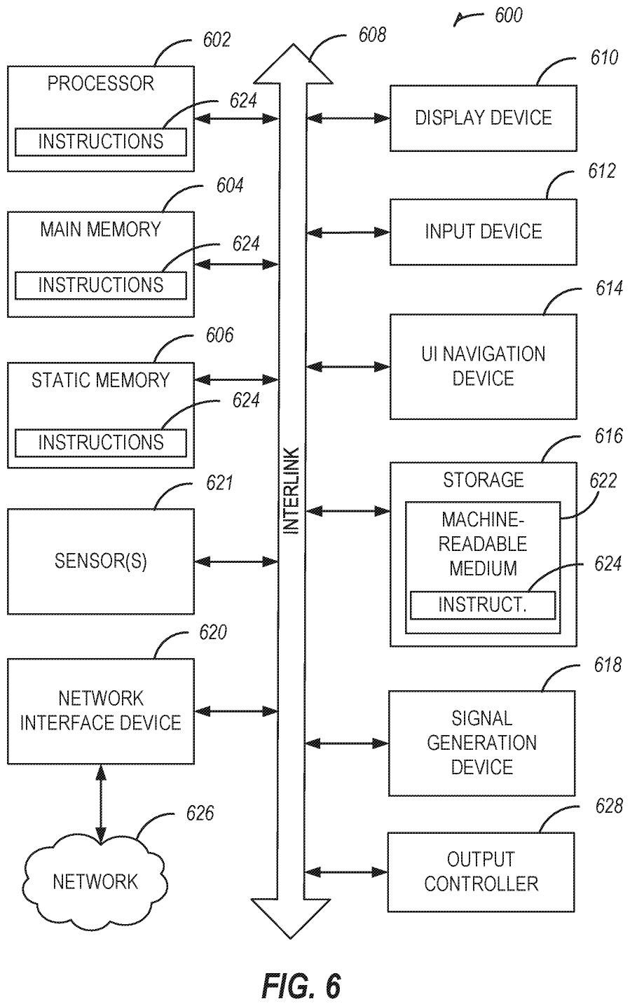

FIG. 5 illustrates a flowchart showing a technique 500 for using a stateless experience API for bill pay in accordance with some examples. In an example, operations of the technique 500 may be performed by processing circuitry, for example by executing instructions stored in memory. The processing circuitry may include a processor, a system on a chip, or other circuitry (e.g., wiring). For example, technique 500 may be performed by processing circuitry of a device (or one or more hardware or software components thereof), such as those illustrated and described with reference to FIG. 6.

The technique 500 includes an operation 502 to receive, for example at a server from a user device, a first stateless experience application programming interface (API) request including bill payment information. The first stateless experience API request may be received from a mobile banking app of the user device. The server may send authentication information extracted from the bill payment information to an authentication server. The authentication information may include a login identifier and an enterprise customer number determined from a token identifier sent in the first stateless experience API. In some examples, the authentication information is determined without accessing any state data for the user device.

The technique 500 includes an operation 504 to receive an indication from the authentication server that authentication of a user device failed.

The technique 500 includes an operation 506 to send, in response to receiving the indication, a reject transaction object to a storage device. The reject transaction object may be stored in temporary storage at the storage device. The reject transaction object may be deleted or replaced after the side channel authentication of the user device. The reject transaction object may be deleted after a particular time period, when a session ends, or when a session is ended. In an example, operation 506 may include sending a rejection notification to the user device.

The technique 500 includes an operation 508 to receive, for example from the user device, a second stateless experience API request including patched bill payment information after side channel authentication of the user device. The side channel authentication of the user device may be performed using a one time password, in an example. In some examples, in response to success of the side channel authentication, the reject transaction object is replaced by a valid transaction object.

The technique 500 includes an operation 510 to validate the user device by querying the storage device to determine whether the reject transaction object is present. Operation 510 may include querying the storage device for a valid transaction object.

The technique 500 includes an operation 512 to send an indication of authorized payment to a bill pay service based on validation of the user device. The payment may be processed at the bill pay service in response to receiving the indication of the authorized payment at the bill pay service.

The technique 500 may include obtaining payee domain data from the bill pay service before sending the indication of authorized payment. In an example, the technique 500 may include, during a second bill pay attempt by the user device, receiving an indication from the authentication server that authentication of the user device was successful, and in response, sending an indication of authorized payment to the bill pay service.

FIG. 6 illustrates generally an example of a block diagram of a machine 600 upon which any one or more of the techniques (e.g., methodologies) discussed herein may perform in accordance with some examples. In alternative embodiments, the machine 600 may operate as a standalone device or may be connected (e.g., networked) to other machines. In a networked deployment, the machine 600 may operate in the capacity of a server machine, a client machine, or both in server-client network environments. In an example, the machine 600 may act as a peer machine in peer-to-peer (P2P) (or other distributed) network environment. The machine 600 may be a personal computer (PC), a tablet PC, a set-top box (STB), a personal digital assistant (PDA), a mobile telephone, a web appliance, a network router, switch or bridge, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein, such as cloud computing, software as a service (SaaS), other computer cluster configurations.

Examples, as described herein, may include, or may operate on, logic or a number of components, modules, or mechanisms. Modules are tangible entities (e.g., hardware) capable of performing specified operations when operating. A module includes hardware. In an example, the hardware may be specifically configured to carry out a specific operation (e.g., hardwired). In an example, the hardware may include configurable execution units (e.g., transistors, circuits, etc.) and a computer readable medium containing instructions, where the instructions configure the execution units to carry out a specific operation when in operation. The configuring may occur under the direction of the executions units or a loading mechanism. Accordingly, the execution units are communicatively coupled to the computer readable medium when the device is operating. In this example, the execution units may be a member of more than one module. For example, under operation, the execution units may be configured by a first set of instructions to implement a first module at one point in time and reconfigured by a second set of instructions to implement a second module.

Machine (e.g., computer system) 600 may include a hardware processor 602 (e.g., a central processing unit (CPU), a graphics processing unit (GPU), a hardware processor core, or any combination thereof), a main memory 604 and a static memory 606, some or all of which may communicate with each other via an interlink (e.g., bus) 608. The machine 600 may further include a display unit 610, an alphanumeric input device 612 (e.g., a keyboard), and a user interface (UI) navigation device 614 (e.g., a mouse). In an example, the display unit 610, alphanumeric input device 612 and UI navigation device 614 may be a touch screen display. The machine 600 may additionally include a storage device (e.g., drive unit) 616, a signal generation device 618 (e.g., a speaker), a network interface device 620, and one or more sensors 621, such as a global positioning system (GPS) sensor, compass, accelerometer, or other sensor. The machine 600 may include an output controller 628, such as a serial (e.g., universal serial bus (USB), parallel, or other wired or wireless (e.g., infrared (IR), near field communication (NFC), etc.) connection to communicate or control one or more peripheral devices (e.g., a printer, card reader, etc.).

The storage device 616 may include a machine readable medium 622 that is non-transitory on which is stored one or more sets of data structures or instructions 624 (e.g., software) embodying or utilized by any one or more of the techniques or functions described herein. The instructions 624 may also reside, completely or at least partially, within the main memory 604, within static memory 606, or within the hardware processor 602 during execution thereof by the machine 600. In an example, one or any combination of the hardware processor 602, the main memory 604, the static memory 606, or the storage device 616 may constitute machine readable media.

While the machine readable medium 622 is illustrated as a single medium, the term “machine readable medium” may include a single medium or multiple media (e.g., a centralized or distributed database, or associated caches and servers) configured to store the one or more instructions 624.

The term “machine readable medium” may include any medium that is capable of storing, encoding, or carrying instructions for execution by the machine 600 and that cause the machine 600 to perform any one or more of the techniques of the present disclosure, or that is capable of storing, encoding or carrying data structures used by or associated with such instructions. Non-limiting machine-readable medium examples may include solid-state memories, and optical and magnetic media. Specific examples of machine-readable media may include: non-volatile memory, such as semiconductor memory devices (e.g., Electrically Programmable Read-Only Memory (EPROM), Electrically Erasable Programmable Read-Only Memory (EEPROM)) and flash memory devices; magnetic disks, such as internal hard disks and removable disks; magneto-optical disks; and CD-ROM and DVD-ROM disks.

The instructions 624 may further be transmitted or received over a communications network 626 using a transmission medium via the network interface device 620 utilizing any one of a number of transfer protocols (e.g., frame relay, internet protocol (IP), transmission control protocol (TCP), user datagram protocol (UDP), hypertext transfer protocol (HTTP), etc.). Example communication networks may include a local area network (LAN), a wide area network (WAN), a packet data network (e.g., the Internet), mobile telephone networks (e.g., cellular networks), Plain Old Telephone (POTS) networks, and wireless data networks (e.g., Institute of Electrical and Electronics Engineers (IEEE) 802.11 family of standards known as Wi-Fi®, IEEE 802.16 family of standards known as WiMax®), IEEE 802.15.4 family of standards, peer-to-peer (P2P) networks, among others. In an example, the network interface device 620 may include one or more physical jacks (e.g., Ethernet, coaxial, or phone jacks) or one or more antennas to connect to the communications network 626. In an example, the network interface device 620 may include a plurality of antennas to wirelessly communicate using at least one of single-input multiple-output (SIMO), multiple-input multiple-output (MIMO), or multiple-input single-output (MISO) techniques. The term “transmission medium” shall be taken to include any intangible medium that is capable of storing, encoding or carrying instructions for execution by the machine 600, and includes digital or analog communications signals or other intangible medium to facilitate communication of such software.

The following, non-limiting examples, detail certain aspects of the present subject matter to solve the challenges and provide the benefits discussed herein, among others.
Example 1 is a method comprising: receiving, from a user device, a first stateless experience application programming interface (API) request including bill payment information; sending, to an authentication server, authentication information extracted from the bill payment information; receiving an indication from the authentication server that authentication of the user device failed; sending, in response to receiving the indication, a reject transaction object to a storage device; sending, in response to receiving the indication, a rejection notification to the user device; receiving, from the user device, a second stateless experience API request including patched bill payment information after side channel authentication of the user device; validating the user device by querying the storage device to determine whether the reject transaction object is present; and sending an indication of authorized payment to a bill pay service based on validation of the user device.
In Example 2, the subject matter of Example 1 includes, wherein the first stateless experience API is received from a mobile banking app of the user device.
In Example 3, the subject matter of Examples 1-2 includes, obtaining payee domain data from the bill pay service before sending the indication of authorized payment.
In Example 4, the subject matter of Examples 1-3 includes, wherein the authentication information includes a login identifier and an enterprise customer number determined from a token identifier sent in the first stateless experience API.
In Example 5, the subject matter of Examples 1-4 includes, wherein the authentication information is determined without accessing any state data for the user device.
In Example 6, the subject matter of Examples 1-5 includes, during a second bill pay attempt by the user device, receiving an indication from the authentication server that authentication of the user device was successful, and in response, sending an indication of authorized payment to the bill pay service.
In Example 7, the subject matter of Examples 1-6 includes, wherein the reject transaction object is stored in temporary storage at the storage device and is deleted after the side channel authentication of the user device.
In Example 8, the subject matter of Examples 1-7 includes, wherein the side channel authentication of the user device is performed using a one time password, and in response to success of the side channel authentication, the reject transaction object is replaced by a valid transaction object, and wherein validating the user device includes querying the storage device for the valid transaction object.
In Example 9, the subject matter of Examples 1-8 includes, wherein the payment is processed at the bill pay service in response to sending the indication of authorized payment to the bill pay service.
Example 10 is a system comprising: an application programming interface (API) server to: receive, from a user device, a stateless experience API request including bill payment information; an authentication server to: receive, from the API server, authentication information extracted from the bill payment information; determine whether the user device is authenticated for paying a particular bill passed on the authentication information; and send, to the API server, an indication that authentication of the user device failed; a storage device to: receive, from the API server in response to receiving the indication, a reject transaction object; storing the reject transaction object in temporary storage; receive an indication that side channel authentication of the user device has occurred; and in response to receiving the indication that side channel authentication of the user device has occurred, replace the reject transaction object with a valid transaction object in the temporary storage; and a bill pay service to: receive authorization for payment of the particular bill based on validation of the user device via identification of the valid transaction object in the temporary storage.
In Example 11, the subject matter of Example 10 includes, wherein the storage device is further to delete the valid transaction object from the temporary storage after the stateless experience API server receives an indication of the valid transaction object.
In Example 12, the subject matter of Examples 10-11 includes, wherein the stateless experience API is received from a mobile banking app of the user device.
In Example 13, the subject matter of Examples 10-12 includes, wherein the authentication information includes a login identifier and an enterprise customer number determined from a token identifier sent in the stateless experience API.
In Example 14, the subject matter of Examples 10-13 includes, wherein the authentication information is determined without accessing any state data for the user device.
In Example 15, the subject matter of Examples 10-14 includes, wherein the side channel authentication of the user device is performed using a one time password.
Example 16 is at least one non-transitory machine-readable medium including instructions, which when executed by processing circuitry, cause the processing circuitry to perform operations to: receive, from a user device, a first stateless experience application programming interface (API) request including transaction information; send, to an authentication server, authentication information extracted from the transaction information; receive an indication from the authentication server that authentication of the user device failed; send, in response to receiving the indication, a reject transaction object to a storage device; send, in response to receiving the indication, a rejection notification to the user device; receive, from the user device, a second stateless experience API request including patched transaction information after side channel authentication of the user device; validate the user device by querying the storage device to determine whether the reject transaction object is present; and send an indication of authorized payment to a transaction service based on validation of the user device.
In Example 17, the subject matter of Example 16 includes, wherein the first stateless experience API is received from a mobile banking app of the user device.
In Example 18, the subject matter of Examples 16-17 includes, wherein the authentication information includes a login identifier and an enterprise customer number determined from a token identifier sent in the first stateless experience API.
In Example 19, the subject matter of Examples 16-18 includes, wherein the authentication information is determined without accessing any state data for the user device.
In Example 20, the subject matter of Examples 16-19 includes, wherein the reject transaction object is stored in temporary storage at the storage device and is deleted after the side channel authentication of the user device.
Example 21 is at least one machine-readable medium including instructions that, when executed by processing circuitry, cause the processing circuitry to perform operations to implement of any of Examples 1-20.
Example 22 is an apparatus comprising means to implement of any of Examples 1-20.
Example 23 is a system to implement of any of Examples 1-20.
Example 24 is a method to implement of any of Examples 1-20.

Method examples described herein may be machine or computer-implemented at least in part. Some examples may include a computer-readable medium or machine-readable medium encoded with instructions operable to configure an electronic device to perform methods as described in the above examples. An implementation of such methods may include code, such as microcode, assembly language code, a higher-level language code, or the like. Such code may include computer readable instructions for performing various methods. The code may form portions of computer program products. Further, in an example, the code may be tangibly stored on one or more volatile, non-transitory, or non-volatile tangible computer-readable media, such as during execution or at other times. Examples of these tangible computer-readable media may include, but are not limited to, hard disks, removable magnetic disks, removable optical disks (e.g., compact disks and digital video disks), magnetic cassettes, memory cards or sticks, random access memories (RAMs), read only memories (ROMs), and the like.

What is claimed is:

1. A method comprising:
receiving, from a user device, a first stateless experience application programming interface (API) request including bill payment information;
sending, to an authentication server, authentication information extracted from the bill payment information;
receiving an indication from the authentication server that authentication of the user device failed;
sending, in response to receiving the indication, a reject transaction object to a storage device;
sending, in response to receiving the indication, a rejection notification to the user device;
receiving, from the user device, a second stateless experience API request including patched bill payment information after side channel authentication of the user device;
validating the user device by querying the storage device to determine whether the reject transaction object is present; and
sending an indication of authorized payment to a bill pay service based on validation of the user device.

2. The method of claim 1, wherein the first stateless experience API is received from a mobile banking app of the user device.

3. The method of claim 1, further comprising obtaining payee domain data from the bill pay service before sending the indication of authorized payment.

4. The method of claim 1, wherein the authentication information includes a login identifier and an enterprise customer number determined from a token identifier sent in the first stateless experience API.

5. The method of claim 1, wherein the authentication information is determined without accessing any state data for the user device.

6. The method of claim 1, further comprising, during a second bill pay attempt by the user device, receiving an indication from the authentication server that authentication of the user device was successful, and in response, sending an indication of authorized payment to the bill pay service.

7. The method of claim 1, wherein the reject transaction object is stored in temporary storage at the storage device and is deleted after the side channel authentication of the user device.

8. The method of claim 1, wherein the side channel authentication of the user device is performed using a one time password, and in response to success of the side channel authentication, the reject transaction object is replaced by a valid transaction object, and wherein validating the user device includes querying the storage device for the valid transaction object.

9. The method of claim 1, wherein the payment is processed at the bill pay service in response to sending the indication of authorized payment to the bill pay service.

10. A system comprising:
a stateless experience application programming interface (API) server to:
receive, from a user device, a stateless experience API request including bill payment information;
an authentication server to:
receive, from the stateless experience API server, authentication information extracted from the bill payment information;
determine whether the user device is authenticated for paying a particular bill passed on the authentication information; and
send, to the stateless experience API server, an indication that authentication of the user device failed;
a storage device to:
receive, from the stateless experience API server in response to receiving the indication, a reject transaction object;
storing the reject transaction object in temporary storage;
receive an indication that side channel authentication of the user device has occurred; and
in response to receiving the indication that side channel authentication of the user device has occurred, replace the reject transaction object with a valid transaction object in the temporary storage; and
a bill pay service to:
receive authorization for payment of the particular bill based on validation of the user device via identification of the valid transaction object in the temporary storage.

11. The system of claim 10, wherein the storage device is further to delete the valid transaction object from the temporary storage after the stateless experience API server receives an indication of the valid transaction object.

12. The system of claim 10, wherein the stateless experience API is received from a mobile banking app of the user device.

13. The system of claim 10, wherein the authentication information includes a login identifier and an enterprise customer number determined from a token identifier sent in the stateless experience API.

14. The system of claim 10, wherein the authentication information is determined without accessing any state data for the user device.

15. The system of claim 10, wherein the side channel authentication of the user device is performed using a one time password.

16. At least one non-transitory machine-readable medium including instructions, which when executed by processing circuitry, cause the processing circuitry to perform operations to:
receive, from a user device, a first stateless experience application programming interface (API) request including transaction information;
send, to an authentication server, authentication information extracted from the transaction information;
receive an indication from the authentication server that authentication of the user device failed;
send, in response to receiving the indication, a reject transaction object to a storage device;
send, in response to receiving the indication, a rejection notification to the user device;
receive, from the user device, a second stateless experience API request including patched transaction information after side channel authentication of the user device;
validate the user device by querying the storage device to determine whether the reject transaction object is present; and
send an indication of authorized payment to a transaction service based on validation of the user device.

17. The machine-readable medium of claim 16, wherein the first stateless experience API is received from a mobile banking app of the user device.

18. The machine-readable medium of claim 16, wherein the authentication information includes a login identifier and an enterprise customer number determined from a token identifier sent in the first stateless experience API.

19. The machine-readable medium of claim 16, wherein the authentication information is determined without accessing any state data for the user device.

20. The machine-readable medium of claim 16, wherein the reject transaction object is stored in temporary storage at the storage device and is deleted after the side channel authentication of the user device.
